(19) United States
(12) Patent Application Publication
(10) Pub. No.: US 2022/0270507 A1
(43) Pub. Date: Aug. 25, 2022

(54) PILOT EDUCATION SYSTEM

(71) Applicant: SUBARU CORPORATION, Tokyo (JP)

(72) Inventors: Koji IKEDA, Tokyo (JP); Takeshi FUKUROSE, Tokyo (JP); Yu ITABASHI, Tokyo (JP); Yousuke OOSAKI, Tokyo (JP); Masahiro SATO, Tokyo (JP); Shunichiro HARA, Tokyo (JP)

(21) Appl. No.: 17/674,336

(22) Filed: Feb. 17, 2022

(30) Foreign Application Priority Data
Feb. 24, 2021 (JP) 2021-027854

(51) Int. Cl. G09B 9/16; G09B 9/44

(52) U.S. Cl. CPC G09B 9/165; G09B 9/44; G09B 9/308

(57) ABSTRACT

A pilot education system includes a learning stage identifier, a teaching information setter, and a practice method setter. The learning stage identifier is configured to identify a learning stage of a trainee to operate either one of an aircraft simulator and an actual aircraft by measuring and analyzing maneuvering skills of the trainee. The maneuvering skills are related to at least one of a sight line or a maneuvering operation. The teaching information setter is configured to set an amount of teaching information to be presented to the trainee in either one of the aircraft simulator and the actual aircraft according to the learning stage identified by the learning stage identifier. The practice method setter is configured to set a practice method for the trainee according to the learning stage identified by the learning stage identifier.

### CROSS-REFERENCE TO RELATED APPLICATIONS

The present application claims priority from Japanese Patent Application No. 2021-027854 filed on Feb. 24, 2021, the entire contents of which are hereby incorporated by reference.

### BACKGROUND

The disclosure relates to a pilot education system that aids training of a pilot.

Hitherto, a drive simulator enabling people to virtually experience driving of an automobile, for example, has been utilized to improve driving techniques of drivers (see, for example, Japanese Unexamined Patent Application Publication No. 2001-318585).

### SUMMARY

An aspect of the disclosure provides a pilot education system including a learning stage identifier, a teaching information setter, and a practice method setter. The learning stage identifier is configured to identify a learning stage of a trainee to operate either one of an aircraft simulator and an actual aircraft by measuring and analyzing maneuvering skills of the trainee. The maneuvering skills are related to at least one of a sight line or a maneuvering operation. The teaching information setter is configured to set an amount of teaching information to be presented to the trainee in either one of the aircraft simulator and the actual aircraft according to the learning stage identified by the learning stage identifier. The practice method setter is configured to set a practice method for the trainee according to the learning stage identified by the learning stage identifier.

An aspect of the disclosure provides a pilot education system including circuitry. The circuitry is configured to identify a learning stage of a trainee to operate either one of an aircraft simulator and an actual aircraft by measuring and analyzing maneuvering skills of the trainee. The maneuvering skills are related to at least one of a sight line or a maneuvering operation. The circuitry is configured to set an amount of teaching information to be presented to the trainee in either one of the aircraft simulator and the actual aircraft according to the learning stage identified. The circuitry is configured to set a practice method for the trainee according to the learning stage identified.

### BRIEF DESCRIPTION OF THE DRAWINGS

The accompanying drawings are included to provide a further understanding of the disclosure and are incorporated in and constitute a part of this specification. The drawings illustrate an example embodiment and, together with the specification, serve to explain the principles of the disclosure.

FIG. 1 is a block diagram illustrating a configuration of a pilot education system;

FIG. 2 is a flowchart illustrating a process flow in the pilot education system;

FIGS. 3A and 3B are each an explanatory view illustrating an example of image data that is obtained by executing a primary process of visualizing and imaging a feature variable in measurement data for a sight line of a trainee operating an aircraft simulator;

FIG. 4 is an explanatory view illustrating a comprehensive learning stage of the trainee;

FIG. 5 is a table illustrating curriculums according to the learning stages, the curriculums being stored in a training curriculum database in a memory; and

FIGS. 6A, 6B, and 6C are each an explanatory view illustrating items displayed on a display of the aircraft simulator.

### DETAILED DESCRIPTION

Recently, due to the shortage of pilots, training the pilots is an urgent issue in the aviation industry.

In the current situation, however, an improvement of efficiency in training an aircraft pilot is not sufficient.

It is desirable to provide a pilot education system capable of improving the efficiency in training the aircraft pilot.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

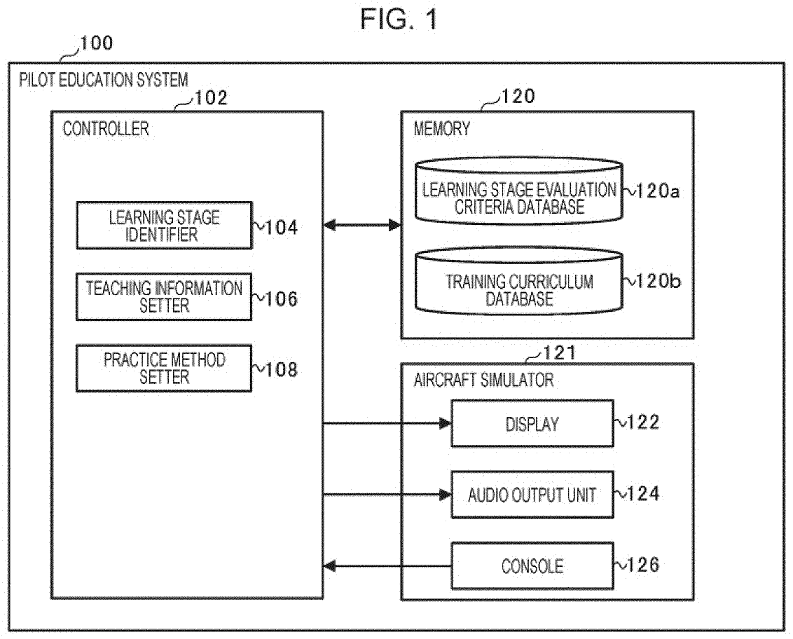

FIG. 1 is a block diagram illustrating a configuration of a pilot education system 100. The pilot education system 100 is constituted by a computer functioning as a virtual reality (VR) training device, a flight simulator, and so on. As illustrated in FIG. 1, the pilot education system 100 includes a controller 102, a memory 120, and an aircraft simulator 121.

The memory 120 is constituted by a RAM, a flash memory, a HDD, or the like. The memory 120 also functions as a learning stage evaluation criteria database 120a and a training curriculum database 120b, which are described in detail later.

The aircraft simulator 121 includes a display 122, an audio output unit 124, and a console 126. The display 122 is constituted by a liquid crystal display, an organic electro luminescence (EL) display, a projector, or the like. The audio output unit 124 is constituted by, for example, a speaker. The console 126 is constituted by various operation switches, levers, and so on for controlling an engine, a fuel system, a power supply system, a landing-gear system, flaps, a flight control system, a ventilation and air-conditioning system, a communication navigation system, and an illumination system.

The controller 102 manages and controls the entirety of the pilot education system 100 by using a semiconductor integrated circuit including, for example, a central processing unit (CPU), a ROM storing programs and so on, and a RAM serving as a work area. In addition, the controller 102 functions as a learning stage identifier 104 that identifies a learning stage of a trainee to operate the aircraft simulator 121 by measuring and analyzing maneuvering skills of the trainee, the maneuvering skills being related to at least either one of a sight line and a maneuvering operation; a teaching information setter 106 that sets an amount of teaching information to be presented to the trainee in the aircraft simulator 121 according to the learning stage identified by the learning stage identifier 104; and a practice method setter 108 that sets a practice method for the trainee according to the learning stage identified by the learning stage identifier 104.

Here, the maneuvering skills for the aircraft are mainly divided into operations (nontechnical skill) to be adapted for ambient environments and basic operations (technical skill) of the aircraft. The nontechnical skill represents a skill demanded for the trainee to recognize the ambient situation and to determine an adequate operation (intention) depending on the situation. The technical skill represents a skill that is professional knowledge and techniques in relation to the aircraft and that is used to appropriately perform an adequate operation in accordance with the prescribed procedures and so on.

The maneuvering skills of the aircraft are progressed roughly through three leaning stages. The first stage is a recognition stage in which the maneuvering skills are at the lowest level. The second stage is an associative stage in which the maneuvering skills are progressed from those in the recognition stage. The third stage is an automatic stage in which the maneuvering skills are progressed from those in the associative stage and adequate maneuvering operations can be more quickly and more accurately derived through a simpler thought process. A beginner pilot whose learning stage is in the recognition stage focuses consciousness on learning of the technical skill. When the learning stage reaches the automatic stage, the trainee can finally deal with individual events without thinking. To efficiently learn the nontechnical skill, therefore, it is desirable for the trainee to start learning of the nontechnical skill after the learning stage of the technical skill has reached the automatic stage and a load imposed on the brain from the learning of the technical skill has reduced. Accordingly, in this embodiment, the efficiency in training the aircraft pilot is improved by setting an adequate training curriculum according to the learning stage.

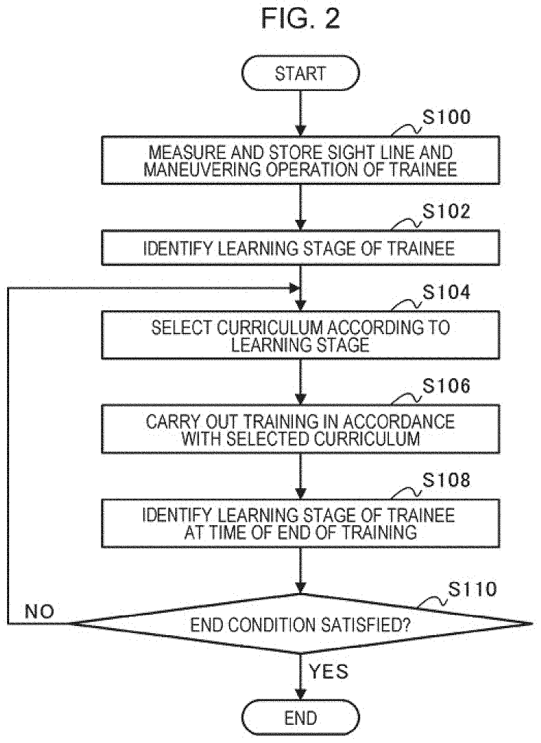

FIG. 2 is a flowchart illustrating a process flow in the pilot education system 100. As illustrated in FIG. 2, first, the controller 102 executes, in the aircraft simulator 121, a simulation with predetermined exercises to identify the learning stage of the trainee and stores, in the memory 120, measurement data obtained by measuring the maneuvering skills of the trainee related to, for example, the sight line and the maneuvering operation (step S100).

In one example, the controller 102 stores in the memory 120, as the measurement data, time-dependent data of an operation input and an operating speed entered by the trainee through the console 126 of the aircraft simulator 121 during the operation of the aircraft simulator 121.

The controller 102 further stores in the memory 120, as the measurement data, time-dependent data regarding indications of various meters in the aircraft simulator 121 operated by the trainee. That time-dependent data relates to, for example, an altitude, a position (latitude and longitude), a speed, rates of climb and descent, a turn rate, an attitude, an azimuth angle, an acceleration, engine meters, fuel meters, a power supply voltage meter, communication navigation instruments, and alert and caution lamps.

The controller 102 further stores in the memory 120, as the measurement data, time-dependent data regarding, for example, a sight line (eyeball), a head direction, a grip strength, and a voice volume of the trainee during the operation of the aircraft simulator 121.

The controller 102 further stores in the memory 120, as the measurement data, time-dependent changes in, for example, an attitude speed and an attitude acceleration during the maneuvering of the aircraft simulator 121.

Measurement data of the above-mentioned various maneuvering skills obtained with at least one veteran pilot is previously stored in the learning stage evaluation criteria database 120a in the memory 120. When multiple models of aircraft are installed in the aircraft simulator 121, the measurement data of the above-mentioned various maneuvering skills obtained with at least one veteran pilot may be stored per model of the aircraft in the learning stage evaluation criteria database 120a in the memory 120 because there are airframe characteristics (such as peculiarities, specific differences, and individual differences) per model.

The learning stage identifier 104 identifies (determines) the learning stage of the trainee based on a matching degree between the measurement data (evaluation criteria) of the maneuvering skills of the veteran pilot stored in the learning stage evaluation criteria database 120a in the memory 120 and the measurement data of the maneuvering skills of the trainee stored in the memory 120 (step S102).

In one example, the learning stage identifier 104 extracts the measurement data of one of the maneuvering skills from among the various measurement data of the various maneuvering skills of the trainee stored in the memory 120. Furthermore, the learning stage identifier 104 extracts the measurement data of the same maneuvering skill as the above-described extracted one from among the various measurement data of the veteran pilot stored in the learning stage evaluation criteria database 120a in the memory 120.

The learning stage identifier 104 quantifies the extracted measurement data of the maneuvering skill of the trainee and the extracted measurement data of the maneuvering skill of the veteran pilot. Thereafter, the learning stage identifier 104 compares the extracted and quantified measurement data of the maneuvering skill of the trainee with the extracted and quantified measurement data of the maneuvering skill of the veteran pilot, and identifies the learning stage for the extracted measurement data of the maneuvering skill based on a matching degree between both the measurement data. Quantification of the measurement data of the maneuvering skill related to the sight line of the veteran pilot may be executed in advance, and quantified values may be stored in the learning stage evaluation criteria database 120a in the memory 120.

The learning stage identifier 104 executes the quantification of the measurement data of the maneuvering skill, by way of example, as follows. To identify the learning stage regarding the sight line of the trainee during the operation of the aircraft simulator 121, the learning stage identifier 104 produces image data indicating a residence time of a pilot's sight point within a certain time during the operation of the aircraft simulator 121 by executing, for example, a primary process of visualizing and imaging a feature variable, thereby quantifying the measurement data of the maneuvering skill related to the sight line.

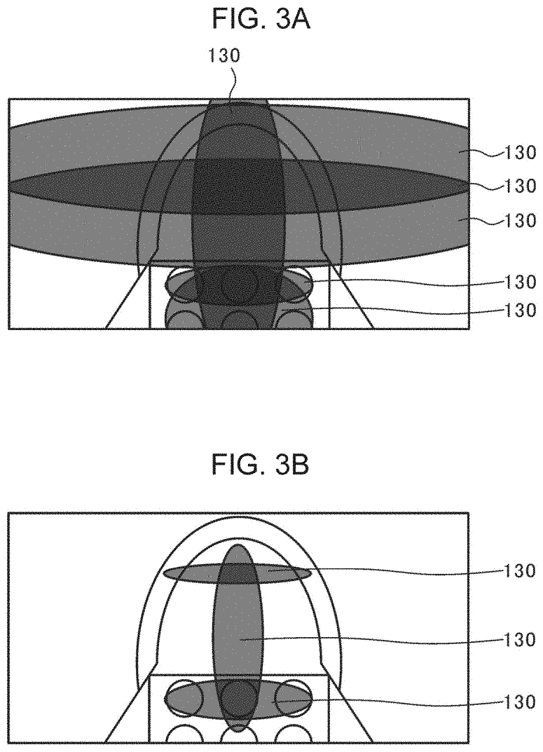

FIGS. 3A and 3B are each an explanatory view illustrating an example of the image data that is obtained by executing the primary process of visualizing and imaging the feature variable in the measurement data for the sight line during the operation of the aircraft simulator 121. FIG. 3A represents the image data for a veteran pilot whose learning stage is in the automatic stage, and FIG. 3B represents the image data for a beginner pilot whose learning stage is in the recognition stage. In the drawings, a darker region 130 indicates that the residence time of the pilot's sight point is longer.

As illustrated in FIG. 3A, the sight line of the veteran pilot during the maneuvering is directed to a wider region 130. On the other hand, as illustrated in FIG. 3B, the sight line of the beginner pilot during the maneuvering is directed to a narrower region 130 than that of the veteran pilot. Therefore, the matching degree of the region 130 between the image data illustrated in FIG. 3A and the image data illustrated in FIG. 3B is relatively low. As the maneuvering skills of the beginner pilot are improved and the learning stage is progressed, the matching degree of the region 130 increases gradually.

By using, as an evaluation criterion, image data that is produced from the measurement data of the maneuvering skill related to the sight line of the veteran pilot during the operation of the aircraft simulator 121, the measurement data being stored in the learning stage evaluation criteria database 120a in the memory 120, the learning stage identifier 104 identifies the learning stage regarding the sight line of the trainee during the operation of the aircraft simulator 121 based on the matching degree between the evaluation criterion and image data that is produced based on the measurement data of the maneuvering skill related to the sight line of the trainee during the operation of the aircraft simulator 121. In one embodiment, the image data produced from the measurement data of the veteran pilot may referred to as “reference image data”. Moreover, in this embodiment, the matching degree is converted to any one of multiple scores set corresponding to the learning stages. At that time, the conversion is performed such that the higher matching degree provides a higher score.

While the above description is made, by way of example, in connection with the case of identifying the learning stage regarding the sight line of the trainee by producing the image data from the measurement data of the maneuvering skill related to the sight line during the operation of the aircraft simulator 121, the disclosure is not limited to that case. Stated in another way, a practical method of identifying the learning stage is not limited to a particular one insofar as the learning stage of the trainee can be identified by analyzing the measurement data of the maneuvering skill of the trainee operating the aircraft simulator 121.

Furthermore, by executing a spectrum analysis (or a wavelet analysis, for example) of the measurement data of the maneuvering skills, such as the maneuvering operation, of the trainee and a spectrum analysis (or a wavelet analysis, for example) of the measurement data, stored in the memory 120, of the maneuvering skills, such as the maneuvering operation, of the veteran pilot, the learning stage identifier 104 analyzes, for example, a cycle, an input, and a rate of the operation made on the console 126, identifies the learning stage regarding the maneuvering of the trainee, and executes the conversion to the score. In one example, the learning stage identifier 104 identifies the learning stage of the trainee for each of the maneuvering skills related to, for example, the altitude, the speed, the rates of climb and descent, the turn rate, the attitude, and executes the conversion to the score. The subjects for each of which the learning stage is to be identified is not limited to the above-mentioned items. The measurement data of the maneuvering skills, such as the maneuvering operation, of the veteran pilot may be quantified in advance and stored in the learning stage evaluation criteria database 120a in the memory 120.

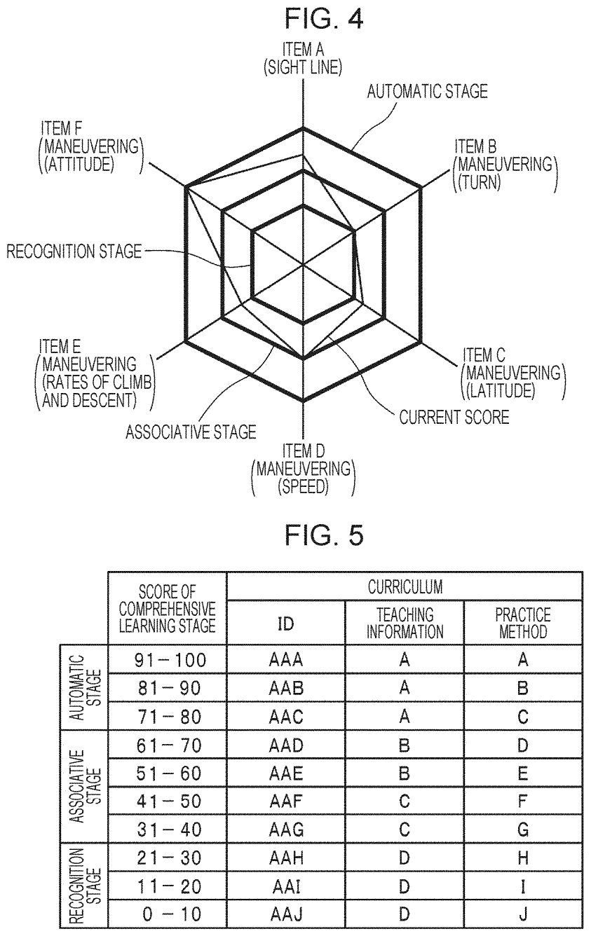

FIG. 4 is an explanatory view illustrating a comprehensive learning stage of the trainee. As illustrated in FIG. 4, the learning stage identifier 104 identifies the comprehensive learning stage of the trainee based on the scores that are obtained, as described above, through the conversion according to the learning stages identified regarding the sight line and the maneuvering of the trainee.

In this embodiment, to identify the comprehensive learning stage, the scores converted according to the identified learning stages regarding the sight line and the maneuvering of the trainee are multiplied and a score (maximum 100 points) of the comprehensive learning stage is determined. Instead of simply multiplying the scores converted according to the identified learning stages regarding the sight line and the maneuvering of the trainee, the score of the comprehensive learning stage may be determined by assigning weights to the individual items and multiplying the weighted scores. Alternatively, the score of the comprehensive learning stage may be determined by simply summing up the scores of the individual items.

FIG. 5 is a table illustrating curriculums corresponding to the learning stages, the curriculums being stored in the training curriculum database 120b in the memory 120. As illustrated in FIG. 5, in this embodiment, when a total score of the comprehensive learning stage is 0 to 30 points, the comprehensive learning stage is identified to be in the recognition stage. When the total score of the comprehensive learning stage is 31 to 70 points, the comprehensive learning stage is identified to be in the associative stage. When the total score of the comprehensive learning stage is 71 to 100 points, the comprehensive learning stage is identified to be in the automatic stage. However, the practical score distribution, illustrated in FIG. 5, representing a correspondence relation between the total score of the comprehensive learning stage and three divisions of the comprehensive learning stage, namely a “recognition stage”, an “associative stage”, and an “automatic stage”, is merely an example, and the score distribution is not limited to such an example. In another example, when the total score of the comprehensive learning stage is 0 to 40 points, the comprehensive learning stage may be identified to be in the recognition stage. When the total score of the comprehensive learning stage is 41 to 80 points, the comprehensive learning stage may be identified to be in the associative stage. When the total score of the comprehensive learning stage is 81 to 100 points, the comprehensive learning stage may be identified to be in the automatic stage. Alternatively, identifying the score of the comprehensive learning stage may be regarded as identifying the learning stage, and a process of linking the total score of the comprehensive learning stage to any one of the “recognition stage”, the “associative stage”, and the “automatic stage” with respect to the comprehensive learning stage may be omitted.

Subsequently, the learning stage identifier 104 and the teaching information setter 106 select a curriculum corresponding to the learning stage (or the total score of the comprehensive learning stage) identified by the learning stage identifier 104 (step S104 in FIG. 2). As described above, the comprehensive learning stage is roughly divided into three stages. In this embodiment, the three learning stages are each further subdivided according to the scores of the comprehensive learning stage, and the curriculum is set corresponding to each subdivision. In this embodiment, ten curriculums are prepared corresponding to ID: AAA to ID: AAJ.

Based on the score of the comprehensive learning stage identified by the learning stage identifier 104, the teaching information setter 106 determines teaching information and a teaching method, which are to be presented to the trainee in the aircraft simulator 121, by referring to the curriculums, illustrated in FIG. 5, stored in the training curriculum database 120b in the memory 120. In this embodiment, the teaching information is prepared in four stages A to D.

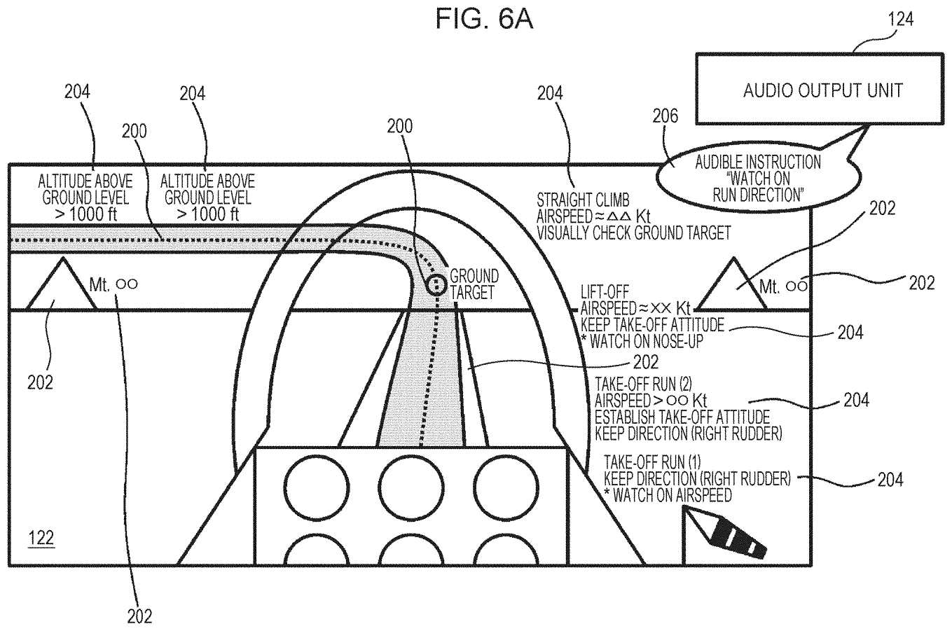

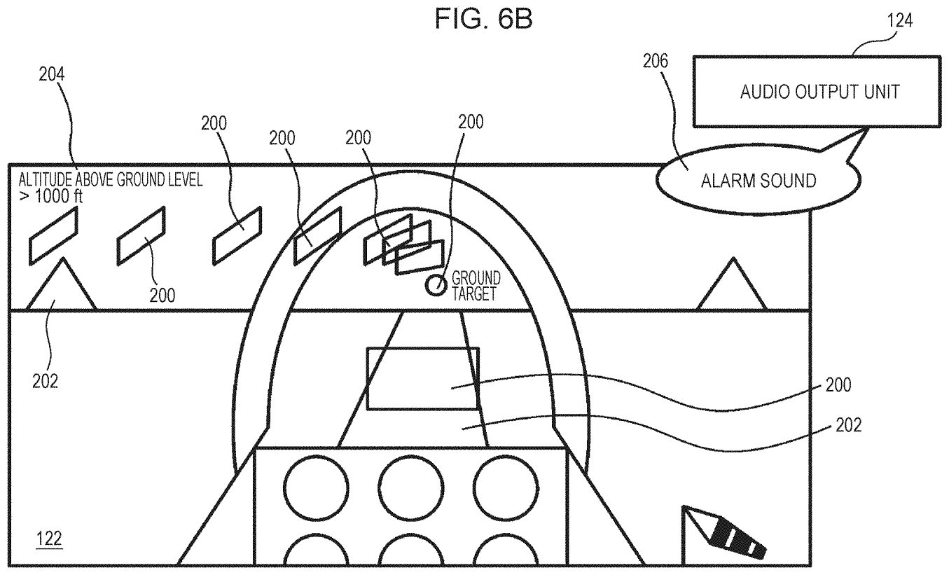

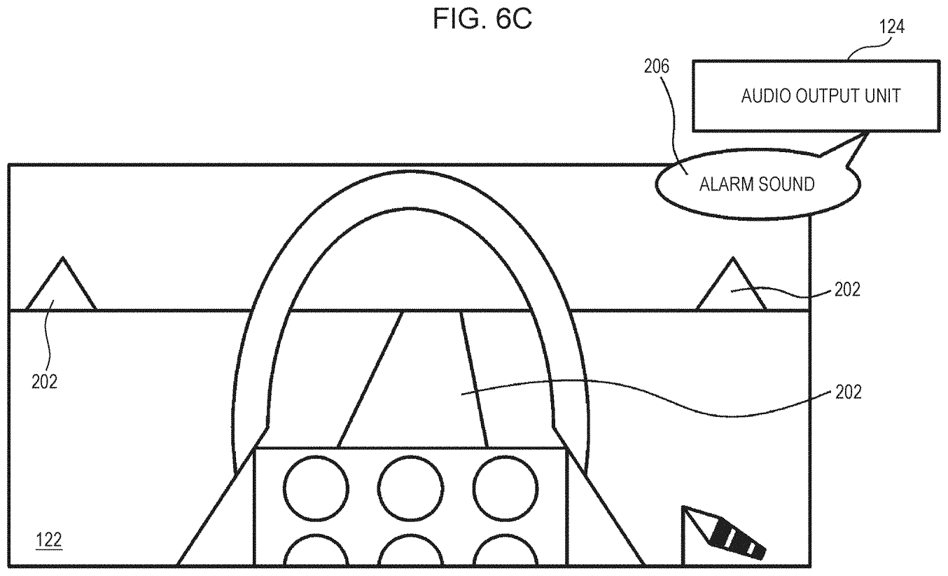

FIGS. 6A, 6B and 6C are each an explanatory view illustrating items displayed on the display 122 of the aircraft simulator 121. As illustrated in FIG. 6A, the teaching information displayed on the display 122 contains, for example, route information 200 for a flight plan, topographic information 202 (such as a topographic image and names and position marks of terrains), operation procedure information 204 (display of, for example, the altitude, the speed, timing, a deviation from the flight plan, a correction method), and audible instruction information 206 (such as propriety of the flight plan, caution, and alarm).

In this embodiment, an amount of the teaching information presented to the trainee on the display 122 of the aircraft simulator 121 is set to reduce as a stage of the teaching information is graded up from D to A. In one example, the route information 200 displayed on the display 122 of the aircraft simulator 121 is restricted step by step such that, as the stage of the teaching information is graded up from D to A, the information is changed in a manner of displaying a route with lines as illustrated in FIG. 6A, then displaying the route with points as illustrated in FIG. 6B, and then not displaying the route as illustrated in FIG. 6C.

The topographic information 202 displayed on the display 122 of the aircraft simulator 121 is restricted step by step such that, as the stage of the teaching information is graded up from D to A, the information is changed in a manner of displaying information of, for example, the names of mountains and marks of ground targets in match with the topographic image (images of the mountains and a runway) as illustrated in FIG. 6A, then displaying just the topographic image and the marks of the ground targets as illustrated in FIG. 6B, and then displaying the topographic image alone as illustrated in FIG. 6C.

The operation procedure information 204 is restricted step by step such that, as the stage of the teaching information is graded up from D to A, the information is changed in a manner of displaying all items of the operation procedure information 204 as illustrated in FIG. 6A, then displaying just part of the operation procedure information 204 as illustrated in FIG. 6B, and then not displaying the operation procedure information 204 as illustrated in FIG. 6C. Thus, the number of the items of the operation procedure information 204 displayed on the display 122 of the aircraft simulator 121 is reduced as the stage of the teaching information is graded up from D to A.

The audible instruction information 206 output from the audio output unit 124 is restricted step by step such that, as the stage of the teaching information is graded up from D to A, the information is changed in a manner of outputting all items of the audible instruction information 206 (propriety of the flight plan, caution, and alarm) from the audio output unit 124, as illustrated in FIG. 6A, and then outputting just one item (alarm) of the audible instruction information 206 as illustrated in FIGS. 6B and 6C. Thus, the frequency at which the audible instruction information 206 is output from the audio output unit 124 is reduced as the stage of the teaching information is graded up from D to A.

The practice method setter 108 sets the practice method for the trainee of the aircraft simulator 121 by referring to the curriculums illustrated in FIG. 5, which are stored in the training curriculum database 120b in the memory 120, based on the score of the comprehensive learning stage identified by the learning stage identifier 104. In this embodiment, the practice method is prepared in ten stages A to J.

The practice method is defined in multiple stages for each of a practice exercise, a practice time, and a practice environment and is set in a combination of the stages in those categories. For example, the practice exercise is prepared in four kinds of exercises for take-off, navigation, landing, and operations from take-off to landing. The practice time is prepared in consideration of, for example, the case of performing short-time exercises with a certain break therebetween, and the case of performing a long-time exercise without a break. The practice environment includes, for example, fine weather, cloudy weather, rainy weather, and an approach of another aircraft. The practice method is set such that, as the stage of the practice method is graded up from J to A, at least one stage of the practice exercise, the practice time, or the practice environment is changed to increase difficulty defined by a combination of the practice exercise, the practice time, and the practice environment.

The controller 102 executes training for the trainee of the aircraft simulator 121 in accordance with the curriculum based on both the stage of the teaching information set by the teaching information setter 106 and the stage of the practice method set by the practice method setter 108 (step S106 in FIG. 2). When the training of the trainee is performed, the learning stage identifier 104 stores the measurement data of the above-described various maneuvering skills in the memory 120.

When the training of the trainee in accordance with the set curriculum is completed, the learning stage identifier 104 identifies the learning stage of the trainee at the time of end of the training (step S108 in FIG. 2). On that occasion, the learning stage of the trainee (the total score of the comprehensive learning stage) at the time of end of the training is identified based on the measurement data of the maneuvering skills stored in the memory 120 during the training of the trainee.

Alternatively, it is also possible to execute a predetermined simulation for identifying the learning stage of the trainee after the end of the training, to store the measurement data of the sight line and the maneuvering operation of the trainee in the memory 120, and to identify the learning stage of the trainee (the total score of the comprehensive learning stage) at the time of end of the training based on the stored measurement data of the maneuvering skills.

The controller 102 determines whether a preset end condition is satisfied (step S110). If the end condition is satisfied (YES in step S110), the controller 102 ends the processing. The end condition may be set as, for example, whether the learning stage of the trainee (the total score of the comprehensive learning stage) at the time of end of the training reaches either one of a predetermined stage and score, or whether a total training time for the trainee reaches a preset time. However, a practical condition set as the end condition is not limited to the above-described example.

On the other hand, if the end condition is not satisfied (NO in step S110), the processing shifts to step S104, and the learning stage identifier 104 and the teaching information setter 106 execute selection of the curriculum according to the learning stage of the trainee (the total score of the comprehensive learning stage) at the time of end of the training (step S104 in FIG. 2). Subsequently, the processing of steps S104 to S110 in FIG. 2 is repeated in the same manner as described above until the end condition is satisfied.

Thus, by repeating the above-described cycle of identifying the learning stage of the trainee and selecting the curriculum according to the learning stage, the curriculum adapted for the learning stage of the trainee can be efficiently carried out. As a result, the leaning stage of the technical skill can be progressed to the automatic stage in a shorter period. Hence a learning time necessary to learn the nontechnical skill can be effectively used, and efficient maneuvering training and flight training can be realized. Stated in another way, the efficiency in training the aircraft pilot can be improved. In addition, since an increase of the efficiency in training the pilot speeds up an improvement of various skills, a dismissal rate of the aircraft pilot due to technical reasons can be reduced.

The embodiment of the disclosure has been described above with reference to the accompanying drawings, but the disclosure is not limited to the above embodiment. It is apparent that those skilled in the art can conceive various modifications or alterations within the scope defined in Claims. Those modifications or alterations also fall within the technical scope of the disclosure.

The kinds of the measurement data of the maneuvering skills explained in the above embodiment are merely illustrative, and the disclosure is not limited to the case of using those kinds of the measurement data.

Curriculums for practice in an actual aircraft may be set in addition to setting the curriculums for the aircraft simulator 121 in the above embodiment. In such a case, the curriculums may be set to prolong a practice time in the actual aircraft or to increase difficulty of the practice as the learning stage (the total score of the comprehensive learning stage) identified by the learning stage identifier 104 is graded up.

Curriculums for training sessions related to the maneuvering of the aircraft may be set in addition to setting the curriculums for the aircraft simulator 121 in the above embodiment. In such a case, the curriculums may be set to shorten a session time or to increase difficulty of the session as the learning stage (the total score of the comprehensive learning stage) identified by the learning stage identifier 104 is graded up.

While the above embodiment has been described in connection with the case of measuring and analyzing the maneuvering skills related to at least one of the sight line or the maneuvering operation of the trainee operating the aircraft simulator 121, the disclosure is not limited to that case. In another example, various measuring devices, such as an eye tracking device, for obtaining additional measurement data with the controller 102 may be mounted on an actual aircraft. The learning stage of the trainee may be identified by measuring and analyzing the maneuvering skills related to at least one of the sight line or the maneuvering operation of the trainee operating the actual aircraft. Furthermore, the display 122 and the audio output unit 124 in the above embodiment may be mounted on the actual aircraft. This enables the teaching information in the above embodiment to be presented to the trainee in the actual aircraft. In such a case, at the time of setting the practice method, the practice method setter 108 can change at least one of the practice exercise, the practice time, or the practice environment for the actual aircraft according to the identified learning stage.

While the above embodiment has been described in connection with the case in which the controller 102 controlling the aircraft simulator 121 functions as the learning stage identifier 104, the teaching information setter 106, and the practice method setter 108, a personal computer, for example, functioning as the learning stage identifier 104, the teaching information setter 106, and the practice method setter 108 may be coupled to the controller 102 controlling the aircraft simulator 121.

The controller 102 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the controller 102 including functions as the learning stage identifier 104, the teaching information setter 106, and the practice method setter 108. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A pilot education system comprising:
a learning stage identifier configured to identify a learning stage of a trainee to operate either one of an aircraft simulator and an actual aircraft by measuring and analyzing maneuvering skills of the trainee, the maneuvering skills being related to at least one of a sight line or a maneuvering operation;
a teaching information setter configured to set an amount of teaching information to be presented to the trainee in either one of the aircraft simulator and the actual aircraft according to the learning stage identified by the learning stage identifier; and
a practice method setter configured to set a practice method for the trainee according to the learning stage identified by the learning stage identifier.

2. The pilot education system according to claim 1, wherein
the teaching information setter is configured to set the amount of the teaching information to be presented to the trainee in either one of the aircraft simulator and the actual aircraft such that the amount of the teaching information is gradually restricted according to the learning stage identified by the learning stage identifier.

3. The pilot education system according to claim 2, wherein
the teaching information contains at least one of teaching of route information related to a preset flight plan on a display of either one of the aircraft simulator and the actual aircraft, teaching of topographic information on the display of either one of the aircraft simulator and the actual aircraft, teaching of operating procedures on the display of either one of the aircraft simulator and the actual aircraft, or an audible instruction to be issued from an audio output unit in either one of the aircraft simulator and the actual aircraft.

4. The pilot education system according to claim 1, wherein
the practice method setter is configured to change, in setting the practice method, at least one of a practice exercise, a practice time, or a practice environment according to the learning stage identified by the learning stage identifier.

5. The pilot education system according to claim 2, wherein
the practice method setter is configured to change, in setting the practice method, at least one of a practice exercise, a practice time, or a practice environment according to the learning stage identified by the learning stage identifier.

6. The pilot education system according to claim 3, wherein
the practice method setter is configured to change, in setting the practice method, at least one of a practice exercise, a practice time, or a practice environment according to the learning stage identified by the learning stage identifier.

7. The pilot education system according to claim 1, wherein
the learning stage identifier is configured to identify the learning stage of the trainee based on a matching degree between reference image data and measurement data, the reference image data being produced from a sight line during operation of either one of the aircraft simulator and the actual aircraft and previously stored in a memory, the measurement data being related to a sight line of the trainee during operation of either one of the aircraft simulator and the actual aircraft.

8. The pilot education system according to claim 2, wherein
the learning stage identifier is configured to identify the learning stage of the trainee based on a matching degree between reference image data and measurement data, the reference image data being produced from a sight line during operation of either one of the aircraft simulator and the actual aircraft and previously stored in a memory, the measurement data being related to a sight line of the trainee during operation of either one of the aircraft simulator and the actual aircraft.

9. The pilot education system according to claim 3, wherein
the learning stage identifier is configured to identify the learning stage of the trainee based on a matching degree between reference image data and measurement data, the reference image data being produced from a sight line during operation of either one of the aircraft simulator and the actual aircraft and previously stored in a memory, the measurement data being related to a sight line of the trainee during operation of either one of the aircraft simulator and the actual aircraft.

10. The pilot education system according to claim 4, wherein
the learning stage identifier is configured to identify the learning stage of the trainee based on a matching degree between reference image data and measurement data, the reference image data being produced from a sight line during operation of either one of the aircraft simulator and the actual aircraft and previously stored in a memory, the measurement data being related to a sight line of the trainee during operation of either one of the aircraft simulator and the actual aircraft.

11. The pilot education system according to claim 5, wherein
the learning stage identifier is configured to identify the learning stage of the trainee based on a matching degree between reference image data and measurement data, the reference image data being produced from a sight line during operation of either one of the aircraft simulator and the actual aircraft and previously stored in a memory, the measurement data being related to a sight line of the trainee during operation of either one of the aircraft simulator and the actual aircraft.

12. The pilot education system according to claim 6, wherein
the learning stage identifier is configured to identify the learning stage of the trainee based on a matching degree between reference image data and measurement data, the reference image data being produced from a sight line during operation of either one of the aircraft simulator and the actual aircraft and previously stored in a memory, the measurement data being related to a sight line of the trainee during operation of either one of the aircraft simulator and the actual aircraft.

13. A pilot education system comprising:
circuitry configured to
identify a learning stage of a trainee to operate either one of an aircraft simulator and an actual aircraft by measuring and analyzing maneuvering skills of the trainee, the maneuvering skills being related to at least one of a sight line or a maneuvering operation,
set an amount of teaching information to be presented to the trainee in either one of the aircraft simulator and the actual aircraft according to the learning stage identified, and
set a practice method for the trainee according to the learning stage identified.
